(19) United States
(12) Patent Application Publication
(10) Pub. No.: US 2011/0110551 A1
(43) Pub. Date: May 12, 2011

(54) Apparatus for Releasably Securing Wireless Communication Device to Head Gear

(76) Inventor: Belinda Baker Ramsey, Los Angeles, CA (US)

(21) Appl. No.: 12/614,793

(22) Filed: Nov. 9, 2009

(51) Int. Cl. H04R 11/04

(52) U.S. Cl. 381/367

(57) ABSTRACT

An apparatus for releasably securing at least one wireless communication device to at least one head gear is disclosed. The apparatus comprises an elongated L-shaped member defined by a proximal, generally a straight portion terminating at a sleeved clip having a left arm and a right arm and a distal, generally a curved portion extending perpendicular to the straight portion and terminating at a circular end member. The circular end member expands around an earbud of a wireless communication device thereby preventing it from falling off. The left arm and the right arm of the sleeved clip attach to a head gear thereby holding the wireless communication device. The head gear may be selected from a group comprised of eyeglasses, sunglasses, helmet, visor, headband or cap. The sleeved clip can be interchangeable with a clamp or elastic tube, and available in different sizes for flexibility.

### CROSS-REFERENCE TO RELATED APPLICATION

Not Applicable

### FEDERALLY SPONSORED RESEARCH

Not Applicable SEQUENCE LISTING OR PROGRAM

Not Applicable

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

The present invention relates in general to holding devices, and more particularly to a simple apparatus for releasably securing a wireless communication device to head gear.

The implementation of bluetooth technology has facilitated the development of wireless devices to a great extent leading to a popular boom in the use of these devices. Bluetooth headsets are great for an easy, wireless conversation with others over the phone while driving, walking, jogging etc, and are required by law in some states while driving. By using wireless technology, two devices can be connected with each other without the use of any cables or wires. There is a further need for an attachment and/or mounting means to securely hold the wireless headset to head gear because the headset can tend to fall out of the ear. Furthermore, eyeglasses, sunglasses, and head gear such as helmets, caps, visors, and headbands, tend to interfere with wireless headsets because all come into contact with the ear, causing the wireless headset to loosen and fall off. Several types of holding devices have been developed in the art to secure a wireless device to prevent it from being damaged or lost.

U.S. Pat. No. 7,409,234 issued to Glezerman describes a communications headset for use with a wireless telephone comprised of a mount and a first and second attachment shaped to secure itself to the mount. The first attachment is configured to secure itself around the ear of a user and the second attachment includes a top portion to secure itself to the frame of a pair of glasses worn by the user. Optionally, the mount includes a slot formed through the housing of the communication headset and the first and second attachments that includes a downwardly dependent leg shaped and sized for receipt in the slot.

U.S. Pat. No. 7,231,038 issued to Warren describes a microphone, transmitter, speaker, receiver, and power source, all mounted to an eyeglasses frame, for sending and receiving signals wirelessly to and from a remote cell phone or other electronic device. The microphone and the transmitter can be mounted to extension arms that can be extended, pivoted, or otherwise moved to a position for use, and then moved to a stored position when not in use. Alternatively, the microphone, transmitter, speaker, receiver, and power source, can be mounted onto a clip-on or other attachment member that mounts onto a conventional eyeglasses frame, hat or other article worn on the head.

Most of these attachments for wireless communication devices described herein are bulky, heavy, uncomfortable, inconvenient to use, and lacking in flexibility. In addition, some of these devices require a complex hinging mechanism and careful manual assembly. They are specifically designed for only one headset. They are also limited in their ability to attach to various types of headgear. They also tend to fail off during strenuous physical activities or exercise.

It is therefore, an object of the present invention to provide a simple safe and compact apparatus, easily releasable, for securing various types of wireless communication devices to various types of eyeglasses, sunglasses, and head gear including helmets, caps, visors, and headbands. Another object of the invention is to provide an apparatus to prevent the headset from falling out of the ear and being damaged or lost, particularly when performing physical activities. Other objects of the present invention will become better understood with reference to appended Summary, Description and Claims.

### SUMMARY

The present invention is an apparatus for releasably securing at least one wireless communication device to at least one head gear. The apparatus comprises an elongated L-shaped member defined by a proximal, generally a straight portion terminating at a sleeved clip having a left arm and a right arm and a distal, generally a curved portion extending perpendicular to the straight portion and terminating at a circular end member. The circular end member will expand around an earbud of the at least one wireless communication device thereby preventing the at least one wireless communication device from falling off. The curved portion of the elongated L-shaped member may be made of flexible material. The left arm and the right arm of the sleeved clip are attached to the at least one head gear and the circular end member expands around an earbud of the at least one wireless communication device thereby securely holding the at least one wireless communication device. The at least one head gear may be selected from a group consisting of eyeglasses, helmet, cap, visor, or headband. The circular end member is flexible and may be made of pliable materials like plastic, rubber etc. The sleeved clip and circular end member may be interchangeable to various sizes depending on the head gear or wireless communication device, respectively.

In one embodiment, an elongated L-shaped member defined by a proximal, generally a straight portion terminating at a clamp that can be attached to the at least one head gear and a distal, generally a curved portion extending perpendicular to the straight portion and terminating at a circular end member. The circular end member will expand around an earbud of the at least one wireless communication device.

In another embodiment, an elongated L-shaped member defined by a proximal, generally a straight portion terminating at an elastic tube that can be attached to the at least one head gear, preferably an eyeglasses and a distal, generally a curved portion extending perpendicular to the straight portion and terminating at a circular end member. The temple of an eyeglasses can be inserted through the elastic tube. The circular end member will expand around an earbud of the at least one wireless communication device.

Although particular embodiments of the present invention have been described in the foregoing description, it is to be understood that the present invention is not to be limited to just the embodiments disclosed, but that they are capable of numerous rearrangements, modifications and substitutions without departing from the description herein.

### BRIEF DESCRIPTION OF THE DRAWINGS

FIG. 1 is a side perspective view of the present invention, illustrating an elongated L-shaped member with a sleeved clip and a circular end member.

FIG. 2 is a perspective view of the present invention when in use with eyeglasses or sunglasses.

FIG. 3 is a perspective view of the present invention when in use with a cap.

FIG. 4 is a perspective view of another embodiment of the present invention, illustrating an elongated L-shaped member with a clamp and a circular end member.

FIG. 5 is a perspective view of yet another embodiment of the present invention, illustrating an elongated L-shaped member with an elastic tube and a circular end member.

### REFERENCE NUMERALS

10 . . . Apparatus of the present invention
12 . . . An elongated L-shaped member
14 . . . Straight portion
16 . . . Sleeved clip
18 . . . Left arm
20 . . . Right arm
22 . . . Curved portion
24 . . . Circular end member
30 . . . At least one wireless communication device
32 . . . Earbud of the at least one wireless communication device
40 . . . At least one head gear
50 . . . Clamp
60 . . . Elastic tube
70 . . . Temple of the eyeglasses

### DETAILED DESCRIPTION

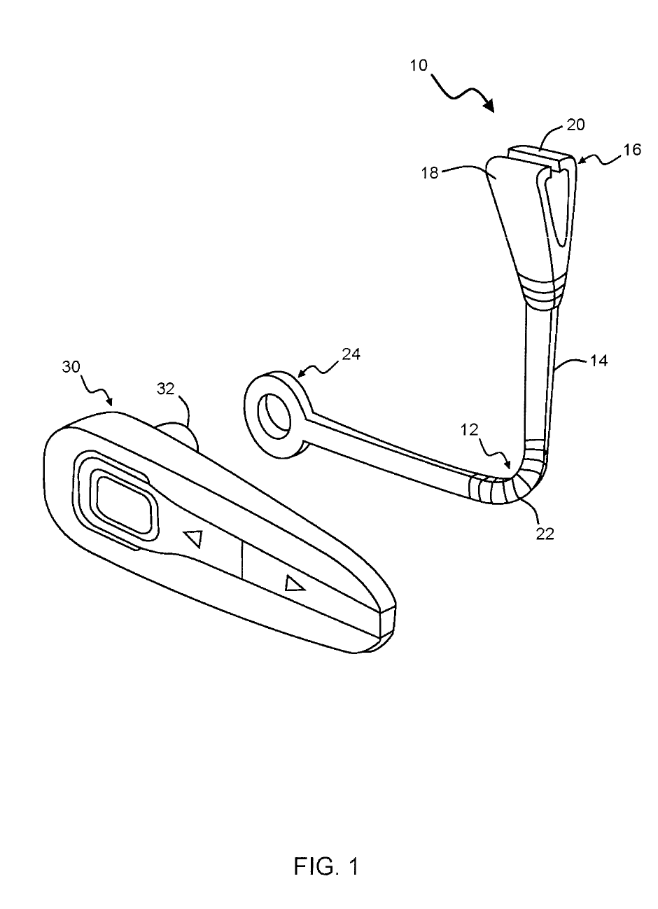

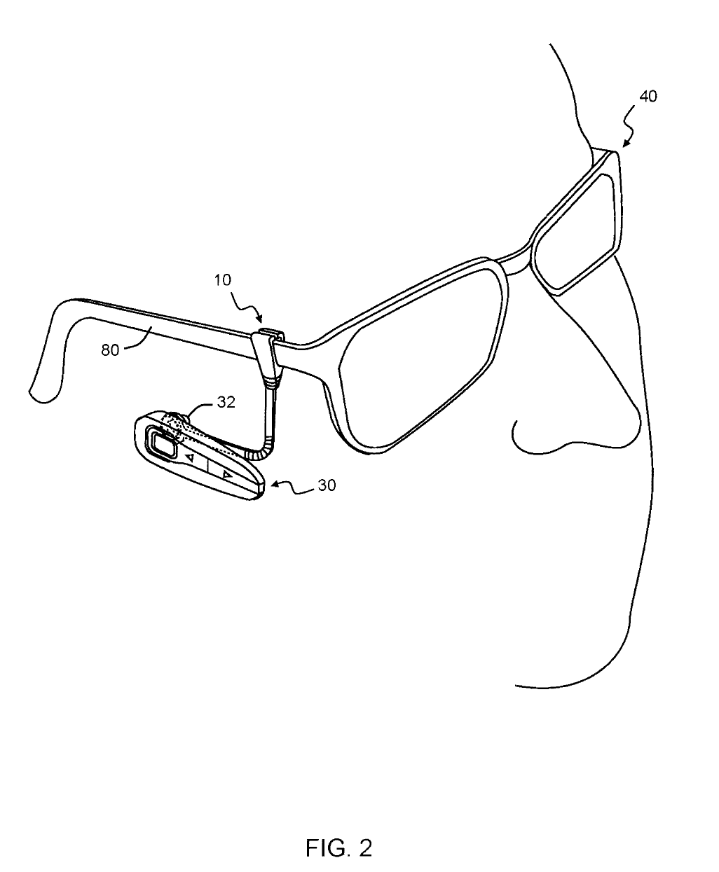

Referring to the drawings, a preferred embodiment illustrates an apparatus 10 for releasably securing at least one wireless communication device 30 to at least one head gear and generally indicated in FIGS. 1 through 2. Referring to FIG. 1, the apparatus 10 comprises an elongated L-shaped member 12 defined by a proximal, generally a straight portion 14 terminating at a sleeved clip 16 having a left arm 18 and a right arm 20 and a distal, generally a curved portion 22 extending perpendicular to the straight portion 14 and terminating at a circular end member 24.

The circular end member 24 will expand around an earbud of the at least one wireless communication device 32 thereby preventing the at least one wireless communication device 30 from falling off. The curved portion of the elongated L-shaped member 26 may be made of flexible material. The circular end member 24 is flexible and may be made of pliable materials like plastic, rubber etc.

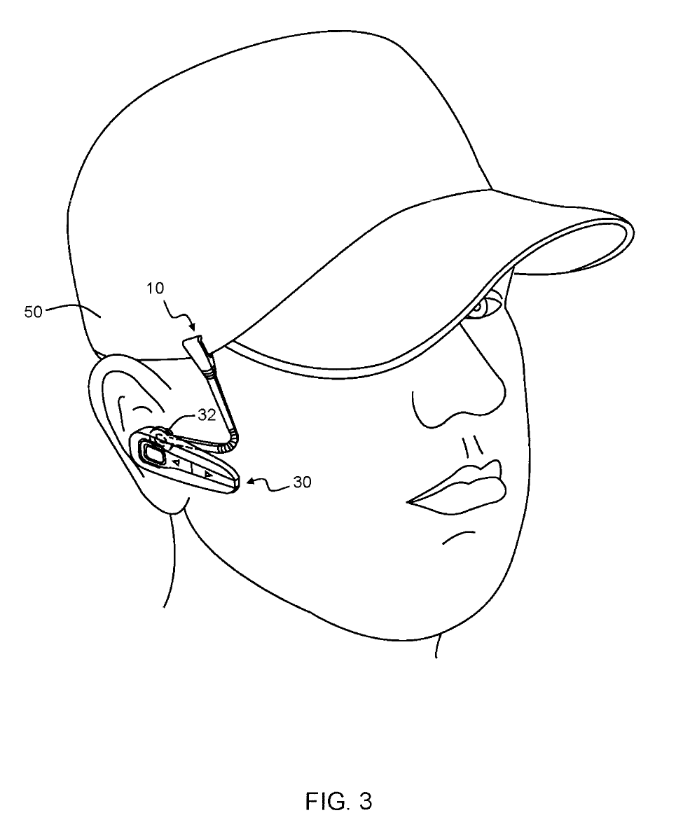

FIG. 2 illustrates the present invention when in use. The left arm 18 and the right arm 20 of the sleeved clip 16 attach to the at least one head gear 40 and the circular end member expands around an earbud of the at least one wireless communication device 32 thereby securely holding the at least one wireless communication device 30. The at least one head gear 40 may be selected from a group consisting of eyeglasses, helmet, cap, visor, or headband. FIG. 2 illustrates the present invention used with eyeglasses while FIG. 3 illustrates the invention used with a cap.

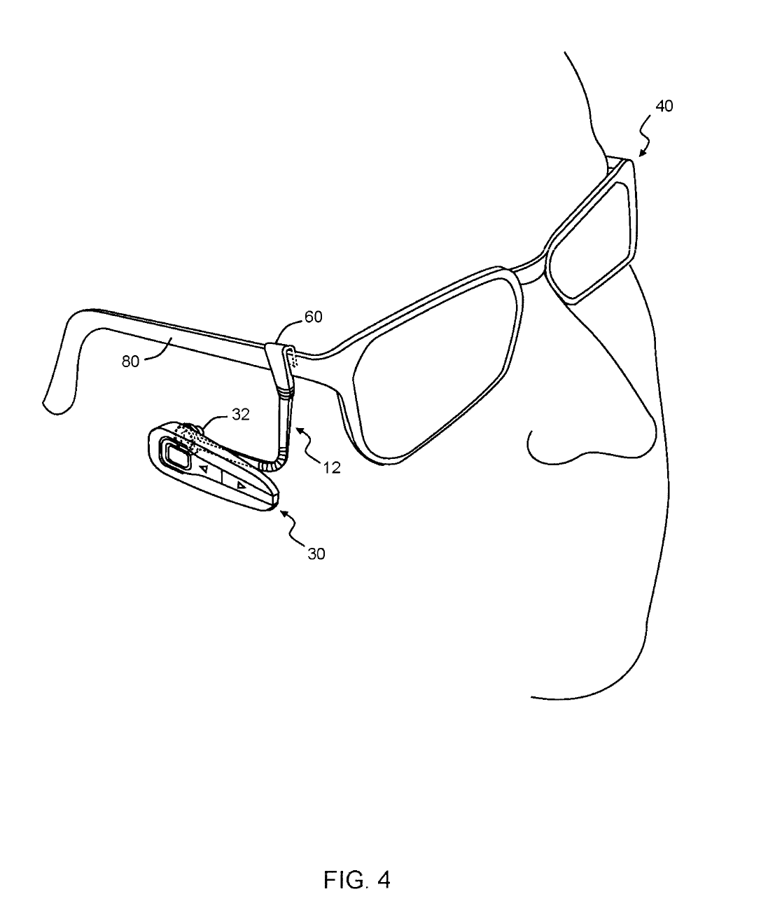

FIG. 4 is an illustration of another embodiment of the invention wherein an elongated L-shaped member 12 is defined by a proximal, generally a straight portion 14 terminating at a clamp 50 that can be attached to the at least one head gear 40 and a distal, generally a curved portion 22 extending perpendicular to the straight portion 14 and terminating at a circular end member 24. The circular end member 24 will expand around an earbud of the at least one wireless communication device 32.

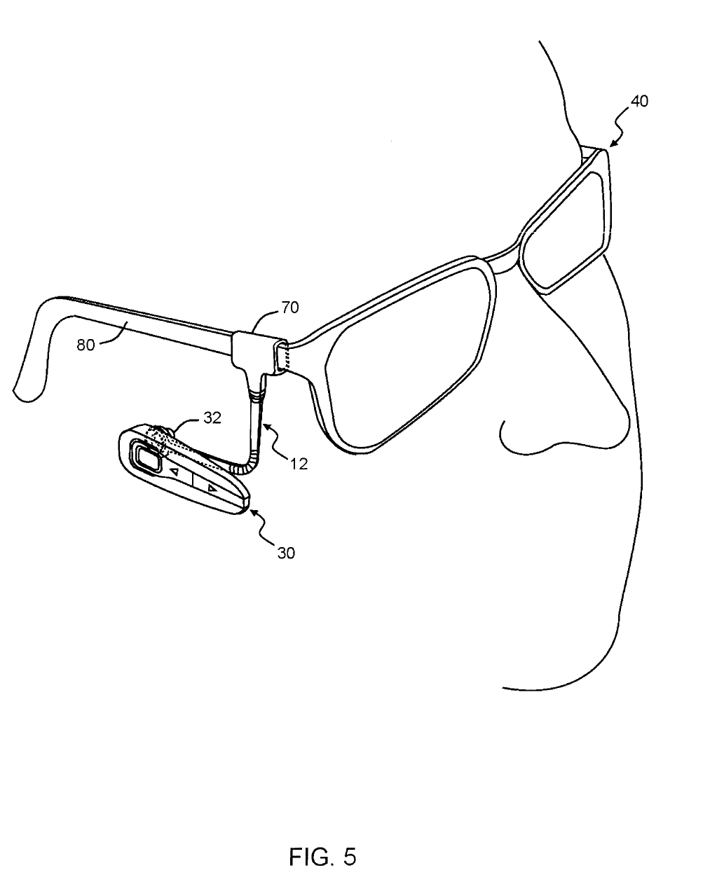

FIG. 5 is an illustration of yet another embodiment of the invention wherein an elongated L-shaped member 12 is defined by a proximal, generally a straight portion 14 connected to an elastic tube 60 that can be attached to the at least one head gear 40 like eyeglasses and a distal, generally a curved portion 22 extending perpendicular to the straight portion 14 and terminating at a circular end member 24. A temple of the eyeglasses 70 can be inserted through the elastic tube 60. The circular end member 24 will expand around an earbud of the at least one wireless communication device 32.

All features disclosed in this specification, including any accompanying claims, abstract, and drawings, may be replaced by alternative features serving the same, equivalent or similar purpose, unless expressly stated otherwise. Thus, unless expressly stated otherwise, each feature disclosed is one example only of a generic series of equivalent or similar features.

Although preferred embodiments of the present invention have been shown and described, various modifications and substitutions may be made thereto without departing from the spirit and scope of the invention. Accordingly, it is to be understood that the present invention has been described by way of illustration and not limitation.

What is claimed is:

1. An apparatus for releasably securing at least one wireless communication device to at least one head gear comprising:
an elongated L-shaped member defined by
a proximal, generally a straight portion terminating at a sleeved clip having a left arm and a right arm; and
a distal, generally a curved portion extending substantially perpendicular to the straight portion and terminating at a circular end member;
whereby the left arm and the right arm of the sleeved clip attach to the at least one head gear and the circular end member expands around an earbud of the at least one wireless communication device to prevent the device from being damaged or lost.

2. The apparatus of claim 1, wherein the curved portion of the elongated L-shaped member may be made of a flexible material.

3. The apparatus of claim 1, wherein the circular end member may be made of a pliable material.

4. The apparatus of claim 1, wherein the at least one head gear may be selected from a group comprised of eyeglasses, sunglasses, helmet, cap, visor, or headband.

5. The apparatus of claim 1, wherein the sleeved clip is interchangeable with different sizes.

6. The apparatus of claim 1, wherein the circular end member is interchangeable with different sizes.

7. An apparatus for releasably securing at least one wireless communication device to at least one head gear comprising:
an elongated L-shaped member defined by
a proximal, generally a straight portion terminating at a clamp; and
a distal, generally a curved portion extending substantially perpendicular to the straight portion and terminating at a circular end member;
whereby the clamp attaches to the at least one head gear and the circular end member expands around an earbud of the at least one wireless communication device to prevent the device from being damaged or lost.

8. The apparatus of claim 7, wherein the curved portion of the elongated L-shaped member may be made of a flexible material.

9. The apparatus of claim 7, wherein the circular end member may be made of a pliable material.

10. The apparatus of claim 7, wherein the at least one head gear may be selected from a group comprised of eyeglasses, sunglasses, helmet, cap, visor, or headband.

11. The apparatus of claim 7, wherein the clamp is interchangeable with different sizes.

12. The apparatus of claim 7, wherein the circular end member is interchangeable with different sizes.

13. An apparatus for releasably securing at least one wireless communication device to at least one head gear comprising:
an elongated L-shaped member defined by
a proximal, generally a straight portion terminating at an elastic tube; and
a distal, generally a curved portion extending substantially perpendicular to the straight portion and terminating at a circular end member;
whereby the elastic tube attaches to the at least one head gear and the circular end member expands around an earbud of the at least one wireless communication device to prevent the device from being damaged or lost.

14. The apparatus of claim 13, wherein the curved portion of the elongated L-shaped member may be made of a flexible material.

15. The apparatus of claim 13, wherein the circular end member may be made of a pliable material.

16. The apparatus of claim 13, wherein the at least one head gear may be selected from a group comprised of eyeglasses, sunglasses, helmet, cap, visor, or headband.

17. The apparatus of claim 13, wherein the elastic tube is interchangeable with different sizes.

18. The apparatus of claim 13, wherein the circular end member is interchangeable with different sizes.
